(19) United States
(12) Patent Application Publication
(10) Pub. No.: US 2011/0050702 A1
(43) Pub. Date: Mar. 3, 2011

(54) CONTRIBUTION BASED CHART SCALING

(75) Inventor: Scott M. Heimendinger, Seattle, WA (US)

(73) Assignee: Microsoft Corporation, Redmond, WA (US)

(21) Appl. No.: 12/550,635

(22) Filed: Aug. 31, 2009

(51) Int. Cl. G06T 11/20

(52) U.S. Cl. 345/440

(57) ABSTRACT

Charts are automatically scaled based on contributing data members. A relatable context of scale is provided by presenting a select group of lowest data members as a combined group such as a combination bar in a bar chart in response to smaller screen size, display area, resolution, and comparable factors. Further information on combined data members may be provided in a condensed graphic format such as a histogram. Value axes of the chart are scaled automatically to enhance visibility and detail of combined data members.

### BACKGROUND

A recent development in electronics industry and use of electronic devices by consumers is the proliferation of handheld computing devices with wireless communication capabilities. Smaller and relatively low-powered transceivers are integrated into a wide variety of devices to enable the automatic exchange of information, and to simplify many processes such as user authentication, contact information exchange between mobile devices, and other similar scenarios.

With the increasing computing power of these smaller devices, a number of applications, typically executed in desktop computing devices, are now available to users in a portable mode. An example group of such applications include those providing charting functionality such as spreadsheet applications. Professions such as sales people can download up-to-date data into their handheld (or vehicle-mount) device, analyze, and view various charts based on the analysis.

One inherent shortcoming of portable computing devices is the relatively small size of their displays. For example, visual media is available to many portable devices such as smart phones. However, the small display size prevents widespread use of video streaming. The experience of watching a movie on a large screen is after all not the same as watching the same on a 2.5 inch by 2.5 inch phone display. Similarly, charts tend to lose their granularity and detail when displayed on a small portable device screen. When translated into a small device display, charts are either visible in segments or scaled down. Segmented charts are difficult to view, while data may lose its meaning in scaled down charts. Thus, user experience is degraded in either case.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing automatic scaling of charts based on contributing data members. A relatable context of scale is provided by presenting a select group of lowest data members as a combined group such as a combination bar in a bar chart, a histogram, and comparable forms. According to some embodiments, the automatic chart scaling (e.g. condensing) may be provided in response to user actions on an interactive display.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example bar diagram on a desktop computing display;

FIG. 2 includes the example bar diagram of FIG. 1 displayed on a smaller scale portable device display illustrating how data may lose its meaning and another example bar diagram with fewer data points illustrating the better legibility of the latter diagram;

FIG. 3 is an example bar diagram with relatively large number of data points;

FIG. 4 illustrates how the example bar diagram of FIG. 3 may be scaled based on contributing data members in a system according to embodiments;

FIG. 5 illustrates how the example bar diagram of FIG. 3 may be scaled based on contributing data members with even fewer contributing members in a system according to embodiments;

FIG. 6 illustrates how the example bar diagram of FIG. 3 may be scaled based on contributing data members combining all but the first data member according to one embodiment;

FIG. 7 illustrates another version of the scaled bar diagram of FIG. 6 according to another embodiment;

FIG. 8 illustrates how an example pie diagram may be scaled based on contributing data members in a system according to embodiments;

FIG. 9 is a networked environment, where a system according to embodiments may be implemented;

FIG. 10 is a block diagram of an example computing operating environment, where a charting application according to embodiments may be implemented; and

FIG. 11 illustrates a logic flow diagram for a process of providing an automatically scaled chart based on contributing data members.

### DETAILED DESCRIPTION

As briefly described above, a user's experience in viewing a chart on a smaller display may be enhanced by automatically scaling the chart based on its contributing data members. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media. The computer program product may also be a propagated signal on a carrier (e.g. a frequency or phase modulated signal) or medium readable by a computing system and encoding a computer program of instructions for executing a computer process.

Throughout this specification, the term “platform” may be a combination of software and hardware components for providing chart applications. Examples of platforms include, but are not limited to, a hosted service executed over a plurality of servers, an application executed on a single server, and comparable systems. The term “server” refers to a computing device executing one or more software programs typically in a networked environment. The term “client” refers to a computing device or software application that provides a user access to data and other software applications through a network connection with other clients and/or servers. More detail on these technologies and example operations is provided below.

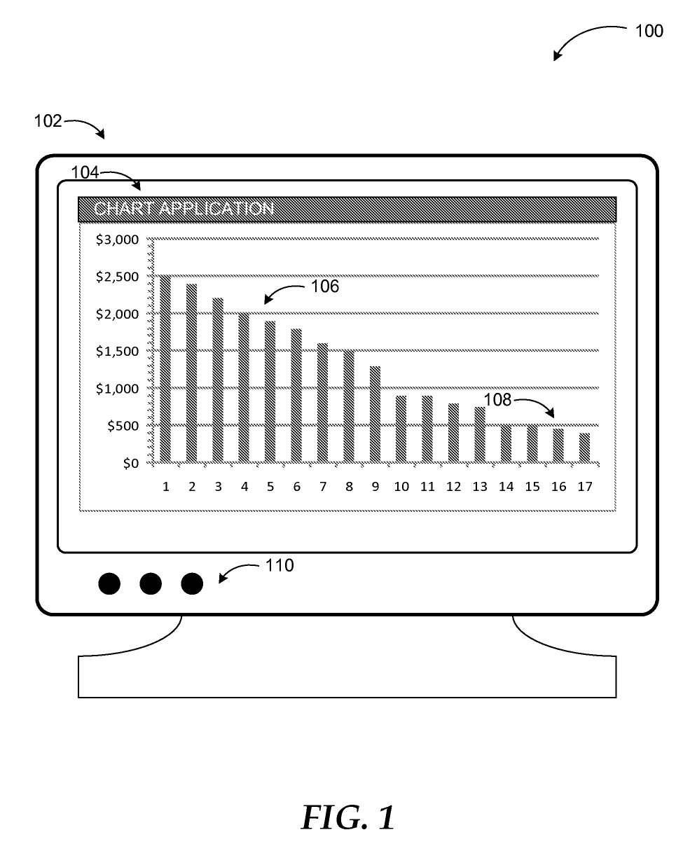

FIG. 1 illustrates an example bar diagram on a desktop computing display. Desktop computer display 102 with controls 110 is typically capable of displaying charts and other items in relative detail due to available size of displayable area. Thus, a chart like bar chart 104 displayed in the figure can be shown with sufficient detail even if the number of the graphic data elements is large.

Some charts, like the example bar chart 104, may include a number of significant elements and a number of smaller, less significant elements. For example, data elements 106 may have higher values compared to data elements 108. Using a relatively large computer display, all of the data elements in the chart may be displayed without degrading visibility and detail of the chart.

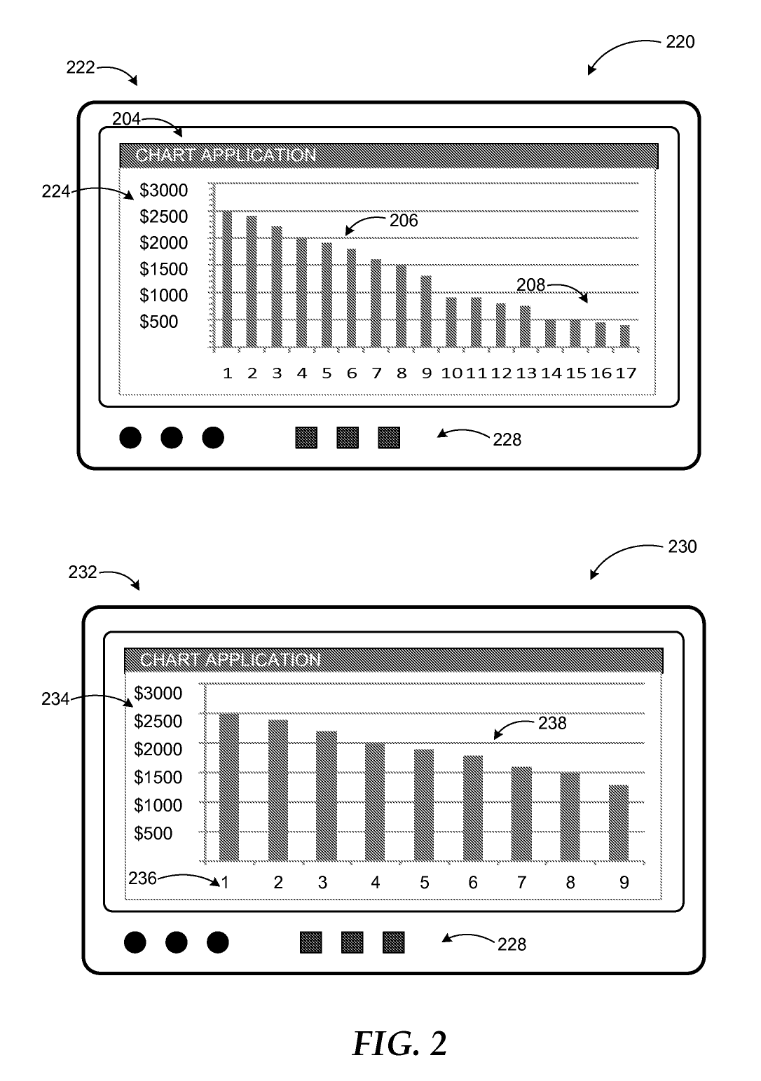

FIG. 2 includes the example bar diagram of FIG. 1 displayed on a smaller scale portable device display illustrating how data may lose its meaning and another example bar diagram with fewer data points illustrating the better legibility of the latter diagram.

Display 222 in diagram 220 may be a mobile computing device screen or similar display with controls 228. When charts are scaled down to fit small screen resolutions or constrained to a smaller region such as on a dashboard page, visibility and detail of data is degraded. While higher value (vertical axis) data elements such as data elements 206 are can still be distinguished along the vertical axis 224, it is relatively difficult to distinguish the smaller data elements (208). Thus, the overall value of the chart is degraded due to scaling, when the whole chart is scaled uniformly.

In contrast to the chart 204 of diagram 220, chart 232 of diagram 230 illustrates a bar chart with relatively small number of data elements 238. Thus, the data elements are clearly visible and a user can easily distinguish vertical axis (234) values of the data elements. Furthermore, the data elements 238 are also spread out along the horizontal axis 236 further enabling the user to view the elements with ease.

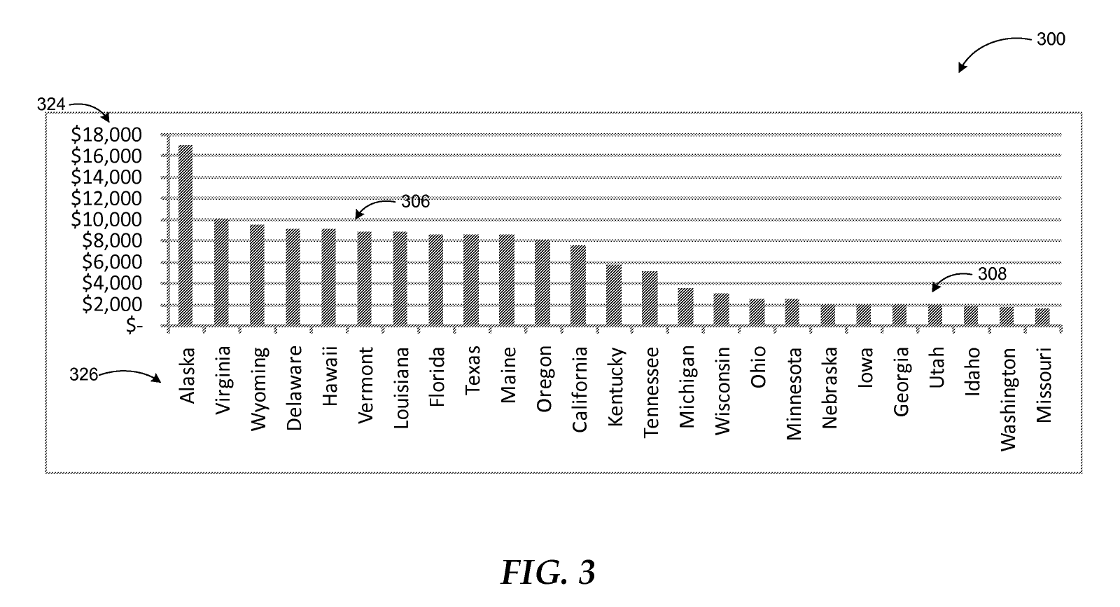

FIG. 3 is an example bar diagram with relatively large number of data points. The example chart illustrated in diagram 300 reflects per capita health care expenditures of various states. The expenditures are shown along the vertical axis 324, while the states are listed along the horizontal axis 326.

As show in the diagram, a number of states have relatively higher expenditures (306), while a group of states have smaller expenditures (308). Due to the large number of data elements (states) differences between the expenditures of the states with smaller expenditures (308) is practically invisible in the chart, even though the chart is shown in a large scale. When the same chart is scaled to fit into a smaller display, not only would the states with smaller expenditures (308) become indistinguishable, but those data elements would push the first group of data elements (states with higher expenditures 306) together causing a degradation of visibility for those elements as well. Thus, whole chart scaling is not a practical solution for a diagram like the example chart shown in this figure.

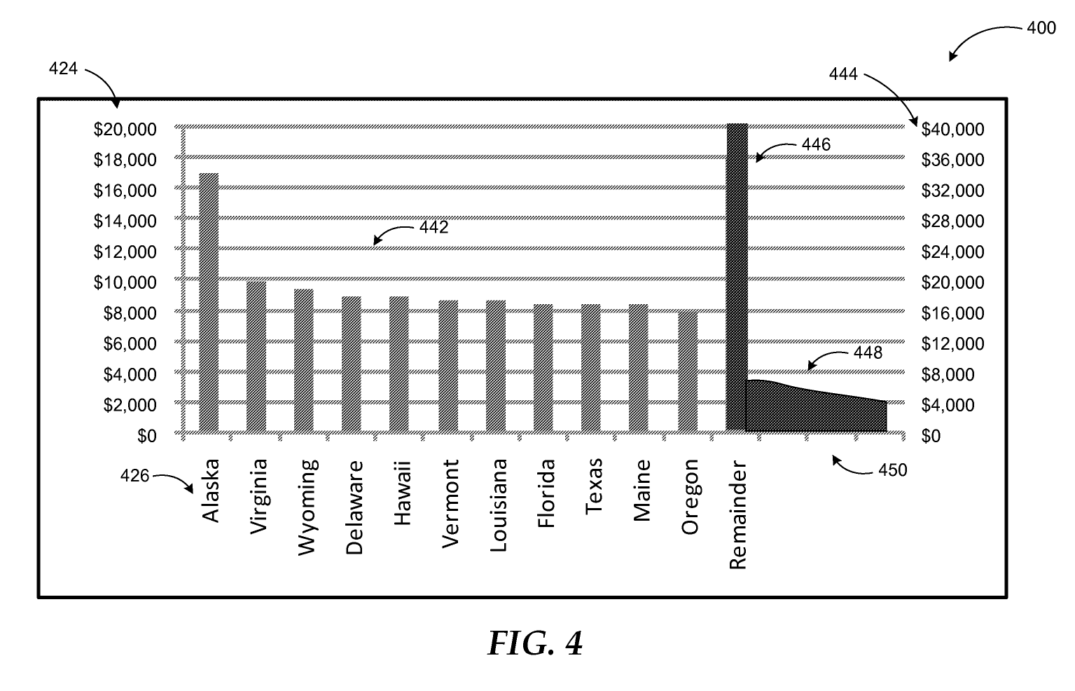

FIG. 4 illustrates how the example bar diagram of FIG. 3 may be scaled based on contributing data members in a system according to embodiments. According to some embodiments, automatic scaling of charts may be provided based on contributing data elements. A relatable context of scale may be provided by presenting a select group of lowest data members as a combined group such as a combination bar in a bar chart, a histogram, and comparable forms. Moreover, the automatic chart scaling (e.g. condensing) may be provided in response to user actions on an interactive display.

As shown in diagram 400 according one embodiment, data elements 442 to be shown individually in the automatically scaled chart are determined based on displayable length of the horizontal axis 426, resolution of the screen, user preferences, or similar factors. Then, a bucket element 446 is created representing the bottom “n” data elements that are to be removed from the horizontal axis. The bucket element represents the combined contribution of the bottom “n” elements. According to another embodiment, further information about the bottom “n” elements may be presented as a histogram 448 next to the bucket element or employing a comparable method in a condensed form.

Right vertical axis 444 may be automatically rescaled such that bucket element 446 can be displayed more visibly (thus, bucket element 446 is according to the scale of the right vertical axis 444 and not according to the left vertical axis 424). Histogram 448 may be displayed according to the left vertical axis 424 or right vertical axis 444. Furthermore, the portion (450) of the horizontal axis 426 corresponding to the histogram may also be resealed to reflect the condensed form of the histogram (or similar representation). Instead of the histogram, a line curve, condensed bars, or similar graphic elements may also be used to represent the bottom “n” elements. Thus, the automatically scaled chart is somewhat similar to two separate charts appended together, but reflecting the same set of data elements.

As mentioned previously, embodiments are not limited to bar charts. Three dimensional column charts (vertical columns), horizontal bar charts, pie charts, donut charts, line graphs, scatter graphs (dots), area charts, surface charts, radar charts (using polar coordinates), and similar ones may also be automatically scaled using the principles described herein.

A general method of automatically scaling charts according to embodiments may begin with determining data elements to be displayed on the chart and ranking them according to their values. Top elements to be displayed individually in the scaled chart may then be determined and a bucket element created combining the remaining data elements. Upon determining the display format of the bucket element, a right vertical axis may be scaled and the bucket element displayed according to the right vertical axis. A condensed representation of the remaining data elements such as a histogram may also be added based on predefined scaling factors such as the left vertical axis (primary value axis) scale, the right vertical axis (secondary value axis) scale, etc. The condensed representation of the remaining elements may be adjacent to the bucket element, overlapping with the bucket element, or separate from the bucket element.

The portion of the horizontal axis corresponding to the histogram may be resealed based on a number of the remaining elements or a size of the horizontal axis. Furthermore, the data elements may be ranked largest to smallest or smallest to largest based on a user preference.

According to an example embodiment, a specific algorithm for automatically scaling charts may include following steps:
1. Ranking the data elements by value, where the rank order (e.g. largest to smallest/smallest to largest) may be parameterized by the user
2. Computing the number of data elements (n) to display along the horizontal axis, as given by the axis dimension (w) of the chart (e.g. width) and the minimum width of a data element (e) as parameterized by the user, where

n=(w/e)−1
3. Including the top n data elements on the horizontal axis
4. Rescaling the right vertical axis as parameterized by the user or through a scaling algorithm
5. Computing the value of the bucket element (b) such that

$$b = {\sum }_{i = 1}^{m} {a}_{i} ,$$

where aᵢ is the value of each of the remaining elements (a total of m remaining data elements)
6. Setting the label for the bucket element to represent the number of data elements included in the bucket (e.g. “Bottom 25”)
7. Placing the bucket element on the horizontal axis in a position parameterized by the user (left, right, etc.)
8. Rescaling the numbers on the right vertical axis (secondary value axis) as parameterized by the user or a scaling algorithm
9. Creating a histogram of the data elements from 0 to n through a histogram drawing algorithm
10. Scaling the histogram according to the scale of the left or right vertical axis (primary or secondary value axis) or any other scale as parameterized by the user
11. Placing the histogram on the horizontal axis in a position parameterized by the user (e.g. next to the bucket element, overlapping with the bucket element, etc.)

According to a further embodiment, various aspects of the automatic scaling of a chart may be performed or adjusted based on user actions such as input through an interactive display. Interactive displays are commonly used in smaller computing devices such as portable computers, smart phones, automobile computers, etc. A user may provide input by tapping on a displayed graphic element or dragging a graphic element to a position. Thus, information on scaling of the secondary value axis (right vertical axis), display position of the histogram, which data elements to include in the bucket element, display position of the bucket element, and other aspects of the chart may be adjusted based on user input through the interactive display. Of course, similar input may be provided by the user through the use of an input device such as a mouse, a touch pen, a keyboard entry, and the like.

According to yet another embodiment, a preview of the automatically scaled chart may be presented to the user based on predefined parameters such as display size, number of data elements, etc. Changes may be made, thereafter, based on user input while adjusting other aspects of the chart automatically based on the user input. For example, the user may move the placement of the histogram in the chart. The scaling of the histogram and the bucket element may be adjusted automatically based on this change to preserve the overall integrity of the chart.

As mentioned above, charts may be automatically scaled based on user interaction with an interactive display device. One example of such an implementation is a computing device like Microsoft Surface® computer by Microsoft Corporation of Redmond, Wash. On this or a similar device, where users may arrange and scale different visualizations of charts—among other things—on a touchable canvas, the user may make gestures to enlarge or shrink a chart area. A chart scaling algorithm according to embodiments may be executed by the processor of the computing device continuously recalculating scaling parameters and adjusting data element representations as discussed previously.

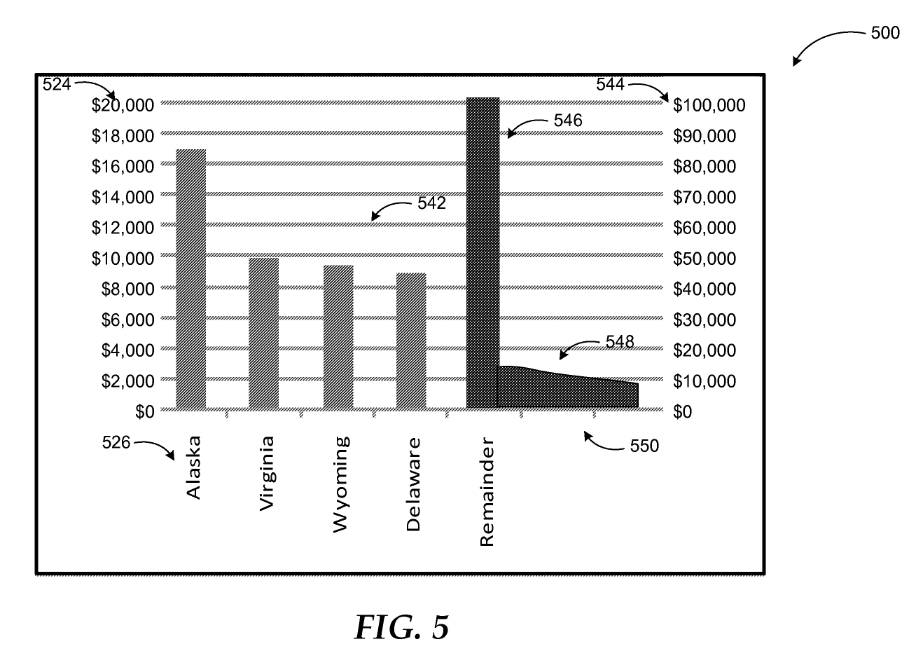

FIG. 5 illustrates how the example bar diagram of FIG. 3 may be scaled based on contributing data members with even fewer contributing members in a system according to embodiments. As discussed above, the number of top n data elements to be displayed individually may be determined based on dynamic factors such as display size, display resolution, user preference, and the like.

Thus, the number of data elements to be displayed individually may be reduced depending on the above mentioned factors or user indication such as through an interactive device display. Diagram 500 includes top four elements 542 displayed across axes 524 and 526. Bucket element 546 is displayed along with histogram 548 representing bucket elements in a condensed fashion. The portion of the horizontal axis 550 corresponding to the histogram, as well as the vertical axis 544 corresponding to the bucket element and the histogram, is automatically scaled to match the change in the bucket element and the histogram. The bucket element has a larger value compared to the chart in FIG. 4 since more data elements are included in the bucket in this example case.

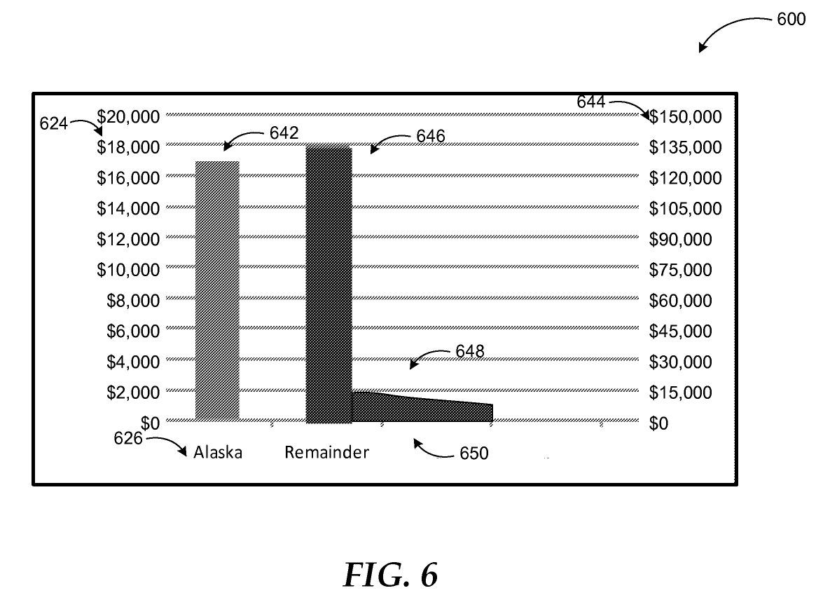

FIG. 6 illustrates how the example bar diagram of FIG. 3 may be scaled based on contributing data members combining all but the first data member according to one embodiment. The chart illustrated in diagram 600 is an example of extremely condensed chart. This may be as a result of a very small display or the user indicating that they are interested in the first data element and bucket element only (e.g. through tapping on the first element or dragging the bucket element next to the first element).

Thus, first data element 642 is displayed across axes 624 and 626. Then, bucket element 646 and the histogram 648 are displayed across horizontal axis portion 650 and vertical scaled axis 644.

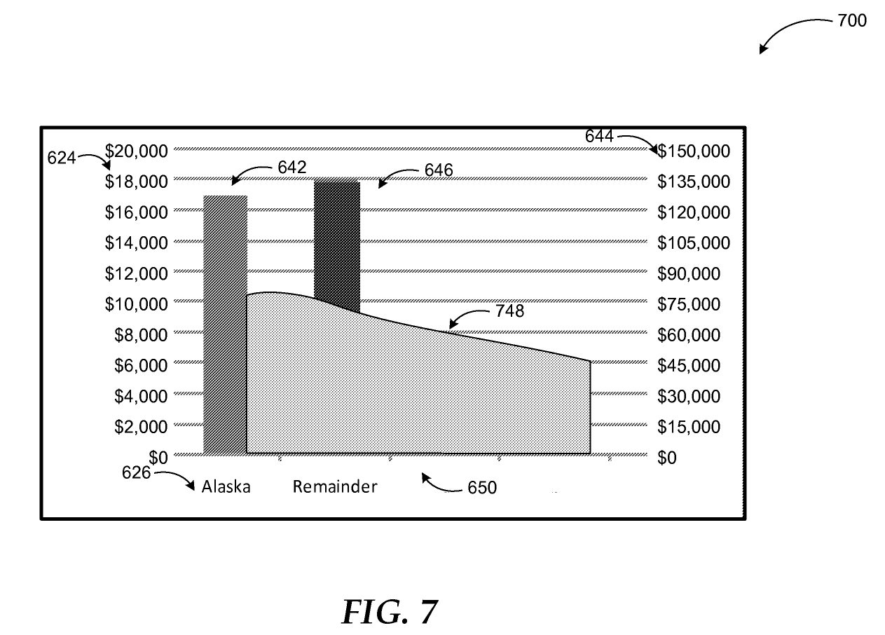

FIG. 7 illustrates another version of the scaled bar diagram of FIG. 6 according to another embodiment. The bucket elements may be represented in various ways in a chart according to embodiments. For example, only the bucket element, only the histogram, a combination of the two (as in diagrams 500 and 600), or other graphical elements may be employed to represent the combined data elements.

In addition, placement of the graphical elements representing the combined data elements may also be varied for enhanced user experience. In the example chart of diagram 700, first data element 642 is displayed across axes 624 and 626. Histogram 748 is displayed next to the first data element across axis 624 and portion of horizontal axis 650. Bucket element 646 is displayed behind the histogram. Scaled axis 644 corresponds to the bucket element.

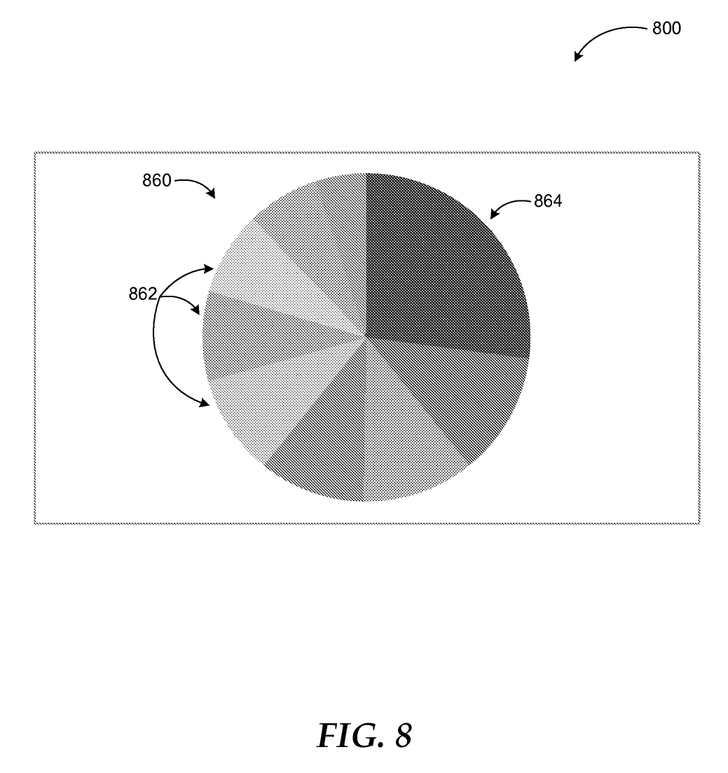

FIG. 8 illustrates how an example pie diagram may be scaled based on contributing data members in a system according to embodiments. As discussed previously, a wide variety of charts may be automatically scaled employing an algorithm according to embodiments. Such charts may include, but are not limited to, column charts (vertical columns), bar charts (horizontal bars), pie charts, donut charts, line graphs, scatter graphs (dots), area charts, surface charts, radar charts (using polar coordinates), and similar ones. These chart types may also include two dimensional or three dimensional representations.

Diagram 800 illustrates an example pie chart 860, where top n elements to be displayed individually (862) are shown in various shades of gray. Bucket element 864, which includes the combination of the remaining elements, is shown in dark grey. Other variations of automatic scaling in pie charts may include adjustment of the radius of the bucket element, use of a gradient color scheme.

While the example charts in FIG. 4 through FIG. 8 have been described with specific elements and graphical schemes, embodiments are not limited to these configurations and can be implemented with other elements and configurations. Furthermore, embodiments are not limited to automatic scaling of charts on portable computing devices. Any computing device with variable display properties may employ chart scaling to enhance user experience. The scaling may be in response to user interaction (e.g. an interactive display), device parameters, chart characteristics, data amount, and other factors.

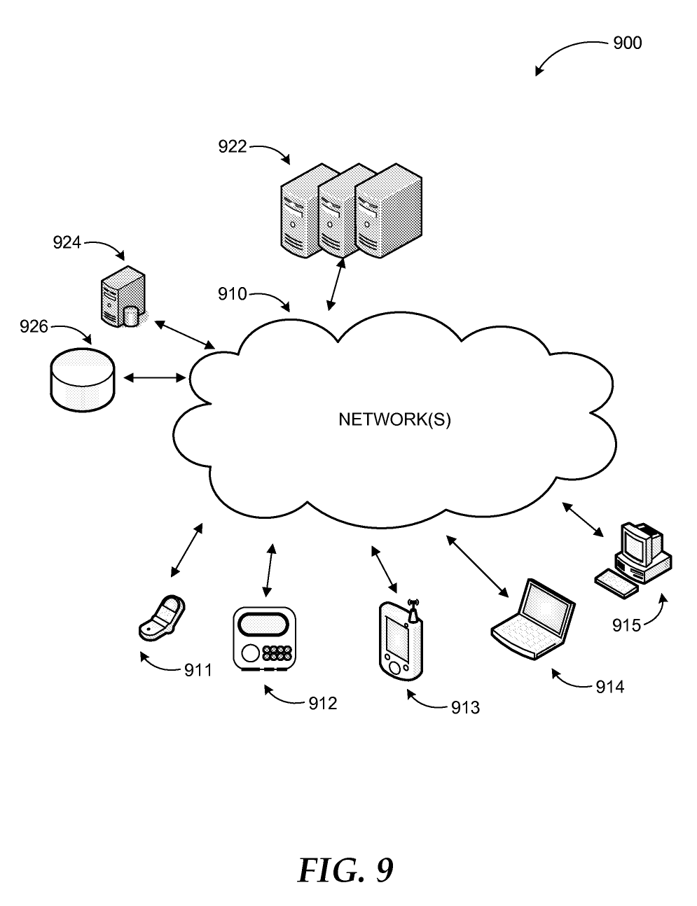

FIG. 9 includes diagram 900 of an example networked environment, where embodiments may be implemented. A platform providing chart scaling based on contributing data members with above discussed features may be implemented via software executed over one or more servers 922 such as a hosted service. The platform may communicate with consuming applications on individual computing devices such as a cellular phone 911, smart automobile console 912, a handheld computer 913, a laptop computer 914, and desktop computer 915 (‘client devices’) through network(s) 910.

As discussed previously, client devices 911-915 are capable of communicating through a variety of modes between subscribers of a communication service. A chart-capable application executed in one of the client devices or by one of the servers 922 may retrieve data from a number of sources such as data store 926, which may be managed by any one of the servers 922 or by database server 924. The chart may then be scaled based on the client device's display capabilities, user parameters, and similar factors by the application and displayed to the user. The chart may also be dynamically rescaled based on user interaction with the display.

Network(s) 910 may comprise any topology of servers, clients, Internet service providers, and communication media. A system according to embodiments may have a static or dynamic topology. Network(s) 910 may include a secure network such as an enterprise network, an unsecure network such as a wireless open network, or the Internet. Network(s) 910 may also comprise a plurality of distinct networks. Network(s) 910 provides communication between the nodes described herein. By way of example, and not limitation, network(s) 910 may include wireless media such as acoustic, RF, infrared and other wireless media.

Many other configurations of computing devices, applications, data sources, and data distribution systems may be employed to implement a system for automatically scaling charts based on contributing data members. Furthermore, the networked environments discussed in FIG. 9 are for illustration purposes only. Embodiments are not limited to the example applications, modules, or processes.

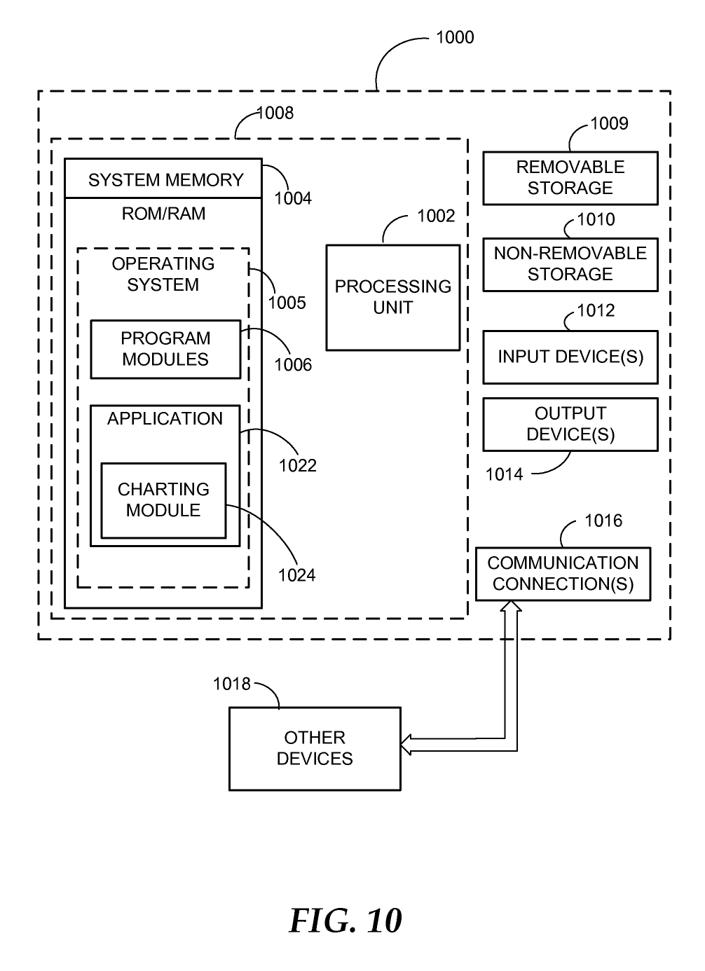

FIG. 10 and the associated discussion are intended to provide a brief, general description of a suitable computing environment in which embodiments may be implemented. With reference to FIG. 10, a block diagram of an example computing operating environment for an application according to embodiments is illustrated, such as computer 1000. In a basic configuration, computer 1000 may include at least one processing unit 1002 and system memory 1004. Computer 1000 may also include a plurality of processing units that cooperate in executing programs. Depending on the exact configuration and type of computing device, the system memory 1004 may be volatile (such as RAM), non-volatile (such as ROM, flash memory, etc.) or some combination of the two. System memory 1004 typically includes an operating system 1005 suitable for controlling the operation of the platform, such as the WINDOWS® operating systems from MICROSOFT CORPORATION of Redmond, Wash. The system memory 1004 may also include one or more software applications such as program modules 1006, application 1022, and charting module 1024.

Application 1022 and charting module 1024 may be separate applications or integral modules of a hosted service that provides computing services to client applications/devices. Application 1022 may provide data organization, analysis, and similar functions (e.g. a spreadsheet application) and provide charts of the organized/analyzed data. Charting module 1024 may, among other things, scale the chart(s) automatically based on contributing data members as discussed in more detail above. Charting module 1024 may further scale chart(s) dynamically in response to user interaction with an interactive display as one of the input devices 1012. This basic configuration is illustrated in FIG. 10 by those components within dashed line 1008.

Computer 1000 may have additional features or functionality. For example, the computer 1000 may also include additional data storage devices (removable and/or non-removable) such as, for example, magnetic disks, optical disks, or tape. Such additional storage is illustrated in FIG. 10 by removable storage 1009 and non-removable storage 1010. Computer readable storage media may include volatile and nonvolatile, removable and non-removable media implemented in any method or technology for storage of information, such as computer readable instructions, data structures, program modules, or other data. System memory 1004, removable storage 1009 and non-removable storage 1010 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computer 1000. Any such computer readable storage media may be part of computer 1000. Computer 1000 may also have input device(s) 1012 such as keyboard, mouse, pen, voice input device, touch input device, and comparable input devices. Output device(s) 1014 such as a display, speakers, printer, and other types of output devices may also be included. An interactive display may act both as an input device and output device. These devices are well known in the art and need not be discussed at length here.

Computer 1000 may also contain communication connections 1016 that allow the device to communicate with other devices 1018, such as over a wireless network in a distributed computing environment, a satellite link, a cellular link, and comparable mechanisms. Other devices 1018 may include computer device(s) that execute communication applications, provide data for application 1022, and so on. Communication connection(s) 1016 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

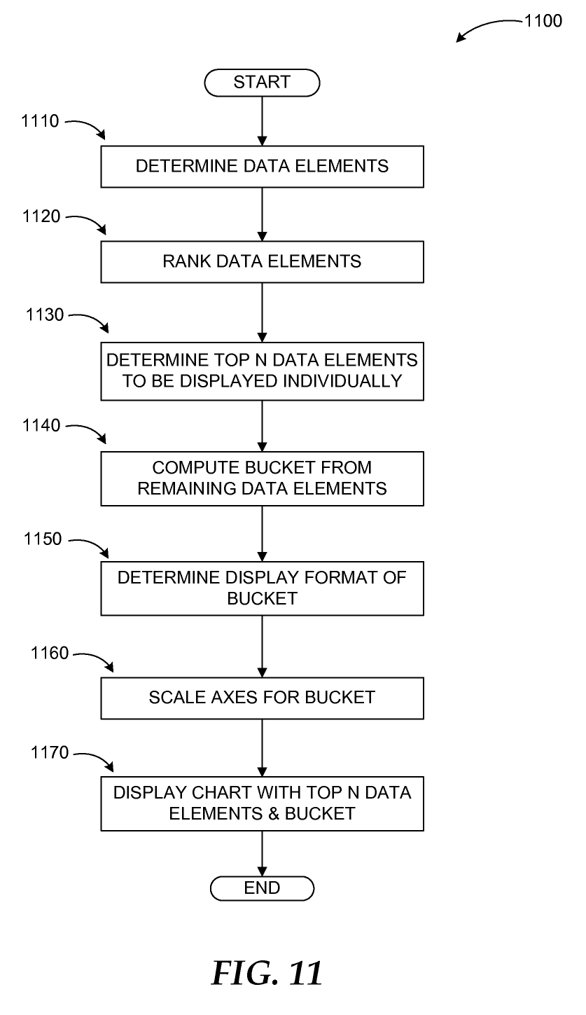

FIG. 11 illustrates a logic flow diagram for process 1100 of providing an automatically scaled chart based on contributing data members. Process 1100 may be implemented by any application displaying charts such as the ones described above.

Process 1100 begins with operation 1110, where data elements to be included in a chart are determined. The data elements may be provided by any application such as a spreadsheet application, an analysis application, a data reporting application, and comparable ones. The data elements may be derived from results of an analysis, from raw data, from user input, and similar sources.

At operation 1120, the data elements to be included in the chart are ranked. The ranking depends on the significance of data such as y-value in a Cartesian coordinate based chart. Other ranking criteria may also be applied. At subsequent operation 1130, top n elements to be displayed individually are determined. This determination may be made automatically based on display capabilities of a device executing the chart application, user preferences, predefined parameters, and similar factors. As discussed previously, top n elements does not limit the chart to one displaying data elements as distinct graphic elements (e.g. a bar chart). A continuous graphic chart such as a line chart or a 3-dimensional surface chart may also be scaled automatically according to embodiments. An example list of charts that may be adjusted automatically has been listed previously.

At operation 1140, a bucket is computed combining data elements not included in the top n. A sum of these remaining data elements determines the value of a bucket element that may be displayed as explained below. At operation 1150, a display format of the data elements in the bucket is determined. The display format may include a single data element representing the bucket value, a histogram representing the remaining data elements in a condensed fashion, a combination of the bucket element and the histogram, or similar formats.

At operation 1160, the axes associated with the bucket (and/or histogram) are scaled automatically to ensure these graphic elements can be displayed without reducing display quality of the top n data elements. Examples of such scaling have been discussed in conjunction with FIGS. 4, 5, 6, and 7. Following the scaling of the axes, the chart including the top n data elements and the representation of the remaining data elements is displayed at operation 1170.

The operations included in process 1100 are for illustration purposes. Providing automatically scaled charts based on contributing data members may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for providing an automatically scaled chart based on data element contribution, the method comprising:
determining data elements to be included in the chart;
ranking data elements based on their values;
determining a first group of data elements to be displayed in the automatically scaled chart;
computing a value of a bucket element by combining values of remaining data elements;
automatically scaling at least one value axis for enhanced display of the bucket element; and
rendering the automatically scaled chart on a display device including the first group of data elements and the bucket element.

2. The method of claim 1, further comprising:
generating a condensed representation of the remaining data elements; and
including the condensed representation of the remaining data elements in the rendered chart.

3. The method of claim 2, wherein the condensed representation of the remaining elements includes one of: a histogram, a line curve, and a condensed version of graphic representation employed for displaying the first group of data elements applied to the remaining data elements.

4. The method of claim 2, wherein the condensed representation of the remaining elements is displayed in one of the following formats: adjacent to the bucket element, overlapping with the bucket element, and separate from the bucket element.

5. The method of claim 2, wherein at least one of the bucket element and the condensed representation of the remaining elements are displayed according to the automatically scaled value axis.

6. The method of claim 2, further comprising:
automatically scaling a portion of a data series axis corresponding to the condensed representation of the remaining elements, wherein the automatically scaled chart displays the data elements along the data series axis and includes at least one value axis.

7. The method of claim 1, wherein the first group of data elements is determined based on at least one from a set of: an available display area, a screen resolution of the display device, and a user preference.

8. The method of claim 1, wherein the automatically scaled chart is a bar diagram with the first group of data elements being displayed as individual bars along a horizontal axis and according to a scale of a left vertical axis, the bucket element being displayed along the horizontal axis and according to a scale of a right vertical axis, and a condensed representation of the remaining data elements being displayed along a scaled portion of the horizontal axis and according to one of the left vertical axis and right vertical axis.

9. The method of claim 8, further comprising:
enabling a user to modify at least one from a set of: a position of the bucket element, a format of the bucket element, a scale of the bucket element, a position of the condensed representation of the remaining data elements, a format of the condensed representation of the remaining data elements, a scale of the condensed representation of the remaining data elements, and a number of data elements to be included in the first group of data elements.

10. The method of claim 1, wherein the automatically scaled chart includes one of: a three dimensional column chart, a two dimensional column chart, a three dimensional horizontal bar chart, a two dimensional horizontal bar chart, a three dimensional pie chart, a two dimensional pie chart, a three dimensional donut chart, a two dimensional donut chart, a line graph, a scatter graph, an area chart, a three dimensional surface chart, and a radar chart.

11. A computing device capable of providing an automatically scaled chart based on data element contribution, the computing device comprising:
a display device;
a memory; and
a processor coupled to the memory, the processor configured to execute a chart application for generating and displaying charts on the display device based on a set of data elements, wherein the chart application is configured to:
rank the data elements based on their values;
determine a first group of data elements to be displayed in the automatically scaled chart according to a primary value axis;
compute a value of a bucket element by combining values of remaining data elements;
generate a condensed representation of the remaining data elements;
automatically scale a secondary value axis and a portion of a data series axis for enhanced display of the bucket element and the condensed representation of the remaining data elements; and
render the automatically scaled chart on the display device including the first group of data elements, the bucket element, and the condensed representation of the remaining data elements.

12. The computing device of claim 11, wherein the chart application is further configured to:
automatically scale the chart based on predefined parameters, available display area, and a resolution of the display device;
render a preview of the automatically scaled chart;
receive an input from a user related to at least one from a set of: a position of the bucket element, a format of the bucket element, a scale of the bucket element, a position of the condensed representation of the remaining data elements, a format of the condensed representation of the remaining data elements, a scale of the condensed representation of the remaining data elements, a size of the data series axis, a size of the primary value axis, a size of the secondary value axis, and a number of data elements to be included in the first group of data elements; and
modify the automatically scaled chart based on the received user input.

13. The computing device of claim 12, wherein the display device is an interactive display device, and wherein the user input is received through one of a tap action and a drag action by the user on a graphical element of the automatically scaled chart.

14. The computing device of claim 13, wherein the chart application is further configured to:
in response to modifying one graphical element of the chart based on user input, automatically modify at least one other graphical element of the chart to preserve an overall integrity of the automatically scaled chart.

15. The computing device of claim 14, wherein the chart is a bar diagram and the condensed representation of the remaining data elements is a histogram, and wherein the chart application is further configured to perform at least one from a set of: adjust a number of data elements in the first group of data elements in response to a drag action by the user, adjust a position of one of the bucket element and the histogram in response to a drag action by the user, adjust a scale of the bucket element according to one of the primary value axis and the secondary value axis in response to a tap action, and adjust a scale of the histogram according to one of the primary value axis and the secondary value axis in response to a tap action.

16. The computing device of claim 11, wherein the automatically scaled chart includes one of: a column chart, a bar chart, a pie chart, a donut chart, a line graph, a scatter graph, an area chart, a surface chart, and a radar chart.

17. A computer-readable storage medium having instructions stored thereon for providing an automatically scaled bar chart based on data element contribution, the instructions comprising:
ranking data elements to be included in the chart based on their values;
computing a first group of data elements (n) to be displayed along a horizontal axis based on a size of the horizontal axis (w) and a minimum width of each bar (e) employing n=(w/e)−1;
computing a value of a bucket element (b) by combining values of remaining data elements;
generating a bar corresponding to the bucket element labeled as combination of the remaining data elements;
automatically scaling a left vertical axis based on a highest value of the first group of data elements;
automatically scaling a right vertical axis for enhanced display of the value (b) bucket element;
generating a condensed histogram corresponding to the remaining data elements;
scaling the histogram according to one of the right vertical axis associated with the bucket element and the left vertical axis associated with the first group of data elements based on a user preference; and
rendering the automatically scaled chart on a display device including the first group of data elements adjacent to the left vertical axis, the bucket element in a position based on a user preference, and the histogram adjacent to the right vertical axis.

18. The computer-readable storage medium of claim 17, wherein the instructions further comprise:
resealing a portion of the horizontal axis corresponding to the histogram based on a number of the remaining elements and a size of the horizontal axis.

19. The computer-readable storage medium of claim 17, wherein the data elements are ranked as one of: largest to smallest and smallest to largest based on a user preference.

20. The computer-readable storage medium of claim 17, wherein the instructions further comprise:
enabling the user to modify one of a position and a scale of one of the bucket element and the histogram; and
automatically adjusting the scales of the left vertical axis, the right vertical axis, and the horizontal axis based on the user modification.
